(19) United States
(12) Patent Application Publication
(10) Pub. No.: US 2024/0022010 A1
(43) Pub. Date: Jan. 18, 2024

(54) ELECTRICAL CONNECTOR STRUCTURE

(71) Applicant: KEMAX SHING CO.,LTD., New Taipei City (TW)

(72) Inventor: CHIH-KUO FENG, New Taipei City (TW)

(21) Appl. No.: 18/105,926

(22) Filed: Feb. 6, 2023

(30) Foreign Application Priority Data
Jul. 12, 2022 (TW) 111126171

(51) Int. Cl. H01R 12/73

(52) U.S. Cl. CPC H01R 12/737

(57) ABSTRACT

An electrical connector structure with high performance to support a new generation hardware structure for high-frequency signal transmission is illustrated. In one of the terminal slots of an upper row and a lower row, there are paired differential signal terminals and two ground terminals, by making the paired differential signal terminals not completely isolated to each other and making the two ground terminals adjacent to the paired differential signal terminals not completely isolated to the differential signal terminals respectively, the two differential signal terminals can efficiently transmit the high-frequency signals at a high speed. Moreover, by disposing the rib on the wall surface and by effectively widening the widths of the conductive terminals and shortening the lengths of the conductive terminals, the impendences which the conductive terminals are exposed to the air can be reduced.

### TECHNICAL FIELD

The present disclosure relates to an electrical connector structure, and in particular, to an electrical connector structure which utilizes a high performance to support a new generation hardware structure for high frequency signal transmission.

### RELATED ART

General electrical connector structures are designed to be acted as connecting elements and accessories for electronic signals and power supplies. Their main functions are to provide electrical connections between various electronic apparatuses or devices to ensure that signals can be accurately transmitted. In addition to the miniaturization design of the current electrical connector structure, the requirements for transmission speed and bandwidth are getting higher and higher. In contrast, the problems caused by high-frequency signal transmission will emerge in endlessly. With the miniaturization of electrical connector structure and the substantial improvement of transmission performance, the number and distribution of terminal groups of the electrical connector structure are also more increasing and dense. However, if the distance between adjacent terminal groups is too close, it will easily cause electromagnetic wave and crosstalk interference during high-frequency signal transmission. Further, the miniaturization of the electrical connector structure will be carried out at a faster speed in the future, and it will make the signal interference problem of the electrical connector structure itself more serious. In addition, for high-frequency connectors, regarding the problems of signal integrity, the problem of crosstalk interference is the most serious. The conventional high-frequency connector comprises an insulating body, an upper row of terminals, a lower row of terminals and a ground plate having ground terminals, wherein all the terminals are installed in the insulating body, and the ground terminals are used to electrically connect with the upper and lower rows of the terminals in series. However, the structure of the ground plate is complicated, and it must be assembled with engaging parts made of insulating materials before it can be further installed inside the insulating body through the engaging parts, and at the same time, the spring arms of the ground plate are respectively in contact with the ground terminals, such that the ground terminals are connected to each other to form a common ground.

TW M565427, which title is “Grounding Structure of Electrical Connector”, discloses the technical features mentioned in the above paragraph. However, the conductive terminal disclosed in TW M565427 have open spaces between each other, and the signals transmitted by the plurality of conductive terminals will easily cause interference. Thus, the Applicant has solved the above problem in TW M574353, which title is “Connector Structure”. TW M574353 discloses a connector structure for transmitting high-frequency signals. The connector structure in TW M574353 at least comprises an insulation base, a plurality of first conductive terminals and a plurality of second conductive terminals. The connector structure in TW M574353 utilizes the hardware design that the first differential signal terminal and the second differential signal terminal adjacent and paired to the first differential signal terminal are not completely insulated to each other to make the high-frequency signals be directly and efficiently transmitted, such that it actually achieve the advantages of reducing the energy loss during the high-frequency signal transmission and improving the quality of the high-frequency signal transmission. In TW M574353, the conventional plastic partition wall between the paired conductive terminals (differential signal terminals) for transmitting signals is cut, so as to increase the high-frequency signal transmission performance of the supported Peripheral Component Interconnect Express (PCIe), and achieve the objective of reducing the energy loss. However, the partition wall between the differential signal terminal and the ground terminal adjacent to the differential signal terminal still exists, which results the insufficient transmission speed. The current market has provided a new generation PCIe hardware structure with higher performance, i.e. the fifth generation of PCIe is evolved from the fourth generation of PCIe, such that the transmission performance of the conventional electrical connector structure cannot support the hardware requirement of the high-frequency signal transmission speed. Therefore, in order to achieve at least one of reducing the energy loss during the high-frequency signal transmission, improving the quality and speed of the high-frequency signal transmission and increasing the bandwidth of the overall electrical connector structure, developers and researchers of related industries need to make continuous efforts to overcome and solve a problem of providing an innovative hardware-related design of the electrical connector structure.

### SUMMARY

Now, in view of the fact that the conventional electrical connector structure still has many shortcomings when it supports the practical application of new generation or type bus and other hardware, the Applicant is diligent to improve the conventional electrical connector structure based on the Applicant's knowledge and experience, and thus an novel electrical connector structure is provided in the present disclosure.

An objective of the present disclosure is to provide an electrical connector structure, and in particular, to provide an electrical connector structure which utilizes a high performance to support a new generation hardware structure for high frequency signal transmission which utilizes a high performance to support a new generation hardware structure for high frequency signal transmission. In the present disclosure, at least one of terminal slots disposed on an upper row and a lower row has a pair of differential signal terminals and two ground terminals, wherein the two differential signal terminals are not completely isolated to each other, the two ground terminals disposed on the two opposite sides of the pair of differential signal terminals, and the ground terminal and the differential signal terminal adjacent to the ground terminal are not completely isolated to each other. By using the above hardware design, the pair of the differential signal terminals can efficiently and fast transmits the high-frequency signals, and further by efficiently increasing widths of conductive terminals and reducing lengths of the conductive terminals, the impendences which the conductive terminals are exposed to the air can be reduced, and it exactly achieves at least one of reducing the energy loss during the high-frequency signal transmission, improving the quality of the high-frequency signal transmission and increasing the bandwidth of the overall electrical connector structure.

To achieve the above objective, an electrical connector structure is provided, and at least comprises an insulation base and a plurality of conductive terminals. The insulation base comprises a first terminal slot, wherein the first terminal slot comprises a plurality of first section regions, a plurality of first partition walls and a plurality of first partitions sheet, wherein the two adjacent first section regions are completely isolated by the first partition wall, and the first partition sheets are disposed on an inner side of the first section region. The conductive terminals comprise a plurality of first conductive terminals inserted in the first section regions, wherein each of the first conductive terminals is a first differential signal terminal or a first ground terminal, the two adjacent first differential signal terminals and the two first ground terminals are inserted in the first section region, and in the first section region, the two first ground terminals are respectively disposed on two opposite sides of the two adjacent first differential signal terminals, and the first partition sheet is disposed between the two adjacent first conductive terminals.

According to the above electrical connector structure, wherein the insulation base further comprises a first side wall, the first side wall is disposed on a side of the first section region same to the inner side of the first section region, each the two first partition sheets form a first terminal accommodation slot, the conductive terminal comprises a body part and a contacting part connected to one end of the body part, the body part of the first conductive terminal is disposed in the first terminal accommodation slot, the contacting part of the first conductive terminal is disposed far away from a wall surface of the first terminal accommodation slot, and a first rib is formed between the wall surface of the first terminal accommodation slot and the contacting part of the first conductive terminal.

According to the above electrical connector structure, wherein the insulation base further comprises a second terminal slot and a card slot, the second terminal slot is disposed on a side of the first terminal slot, the second terminal slot comprises a plurality of second section regions, a plurality of second partition walls and a plurality of second partition sheets, wherein the two adjacent second section regions are completely isolated by the second partition wall, the second partition sheets corresponding to the first partition sheets are disposed on and connected to an inner side of the second section region, the inner side of the second section region is corresponding to the inner side of the first section region, the card slot is opened and disposed between the first terminal slot and the second terminal slot, the conductive terminals comprise a plurality of second conductive terminals inserted in the second section regions, each of the second conductive terminals is a second differential signal terminal or a second ground terminal, the two adjacent second differential signal terminals and the two second ground terminals are inserted in the second section region, and in the second section region, the two second ground terminals are respectively disposed on two opposite sides of the two adjacent second differential signal terminals, and the second partition sheet is disposed between the two adjacent second conductive terminals.

According to the above electrical connector structure, wherein the insulation base further comprises a second partition wall, the second partition wall is disposed on a side of the second section region same to the inner side of the second section region, each the two second partition sheets form a second terminal accommodation slot, the body part of the second conductive terminal is disposed in the second terminal accommodation slot, the contacting part of the second conductive terminal is disposed far away from a wall surface of the second terminal accommodation slot, and a second rib is formed between the wall surface of the second terminal accommodation slot and the contacting part of the second conductive terminal.

According to the above electrical connector structure, wherein each of the conductive terminals comprises a welding part connected to one end of the contacting part, the contacting part has a first width, the welding part has a second width, the first width is 0.66 mm to 0.82 mm, and the second width is 0.52 mm to 0.68 mm.

According to the above electrical connector structure, wherein a height of the first partition sheet is less than a height of the first partition wall, and a height of the second partition sheet is less than a height of the second partition wall.

According to the above electrical connector structure, wherein at least one of the first partition sheet and the second partition sheet is partially removed.

According to the above electrical connector structure, wherein regarding the partially removed the first partition sheet or the second partition sheet, a portion of the first partition sheet or the second partition sheet adjacent to a socket of the card slot is removed.

According to the above electrical connector structure, wherein the first terminal slots further comprise a first slot, the first slot is adjacent to the first section region, the first slot and the first section region are completely isolated by the first partition wall, and one of the conductive terminals is disposed in the first slot.

According to the above electrical connector structure, wherein the second terminal slots further comprise a second slot, the second slot is adjacent to the second section region, the second slot and the second section region are completely isolated by the second partition wall, and one of the conductive terminals is disposed in the second slot.

According to the above electrical connector structure, wherein the insulation base further comprises at least one first support plate and at least one second support plate, the first support plate is disposed between the first terminal slot and the card slot, the second support plate is disposed between the second terminal slot and the card slot.

According to the above electrical connector structure, wherein the electrical connector structure meets a standard of a fifth generation PCIe.

According to the above electrical connector structure, wherein the card slot is provided to a card for insertion, and interior of the card comprises an electrical circuit.

According to the above electrical connector structure, wherein the conductive terminal further comprises an abutting part, one end of the abutting part is connected to the contacting part, and another one end of the contacting part is connected to the abutting part while the end of the contacting part is connected to and the body part.

According to the above electrical connector structure, wherein the abutting part of the conductive terminal in the first terminal slot abuts against the first terminal slot and abuts against the first support plate.

According to the above electrical connector structure, wherein the abutting part of the conductive terminal in the second terminal slot abuts against the second terminal slot and abuts against the second support plate.

According to the above electrical connector structure, wherein the welding part protrudes from the insulation base and is fixed on a circuit board in a fixed manner.

According to the above electrical connector structure, wherein the fixed manner is surface mount or dual in-line package.

Accordingly, in the present disclosure, at least one of terminal slots disposed on an upper row and a lower row has a pair of differential signal terminals and two ground terminals, wherein the two differential signal terminals are not completely isolated to each other, the two ground terminals disposed on the two opposite sides of the pair of differential signal terminals, and the ground terminal and the differential signal terminal adjacent to the ground terminal are not completely isolated to each other. By using the above hardware design, the pair of the differential signal terminals can efficiently and fast transmits the high-frequency signals. Furthermore, by using the design that the ribs are disposed adjacent to the contacting parts of the conductive terminals, since the permittivity of the rib is greater than that of air, the relative permittivity around the plurality of conductive terminals is relatively large, thereby achieving the effect of reducing impedance. Moreover, by effectively widening the widths of the conductive terminals and shortening the lengths of the conductive terminals, the impendences which the conductive terminals are exposed to the air can be reduced, and it exactly achieves at least one of reducing the energy loss during the high-frequency signal transmission, improving the quality of the high-frequency signal transmission and increasing the bandwidth of the overall electrical connector structure.

### BRIEF DESCRIPTIONS OF DRAWINGS

FIG. 1 is a schematic front view showing an overall structure of an electrical connector structure according to one embodiment of the present disclosure.

FIG. 2 is a schematic back view showing an overall structure of an electrical connector structure according to one embodiment of the present disclosure.

FIG. 3 is a schematic explosion diagram showing an overall structure of an electrical connector structure according to one embodiment of the present disclosure.

FIG. 4 is a schematic side view showing an overall structure of an electrical connector structure according to one embodiment of the present disclosure.

FIG. 5 is a schematic diagram showing arrangement of a first terminal slot and a second terminal slot of an electrical connector structure according to one embodiment of the present disclosure.

FIG. 6 is another one schematic diagram showing arrangement of a first terminal slot and a second terminal slot of an electrical connector structure according to one embodiment of the present disclosure.

FIG. 7 is a schematic enlarged view showing partial conductive terminals of an electrical connector structure according to one embodiment of the present disclosure.

FIG. 8 is another one schematic enlarged view showing partial conductive terminals of an electrical connector structure according to one embodiment of the present disclosure.

FIG. 9 is a schematic diagram showing arrangement of conductive terminals of an electrical connector structure according to one embodiment of the present disclosure.

FIG. 10 is a schematic diagram showing a structure of a conductive terminal in an electrical connector structure according to one embodiment of the present disclosure.

FIG. 11 is a schematic three-dimensional view showing a structure of a conductive terminal in an electrical connector structure according to one embodiment of the present disclosure.

FIG. 12A is a schematic curve diagram of a time-varied impendence of a conductive terminal of a conventional electrical connector structure.

FIG. 12B is a schematic curve diagram of a time-varied impendence of a conductive terminal of an electrical connector structure according to one embodiment of the present disclosure.

### DETAILS OF EXEMPLARY EMBODIMENTS

To understand the technical features, content and advantages of the present disclosure and its efficacy, the present disclosure will be described in detail with reference to the accompanying drawings. The drawings are for illustrative and auxiliary purposes only and may not necessarily be the true scale and precise configuration of the present disclosure. Therefore, the scope of the present disclosure should not be limited to the scale and configuration of the attached drawings.

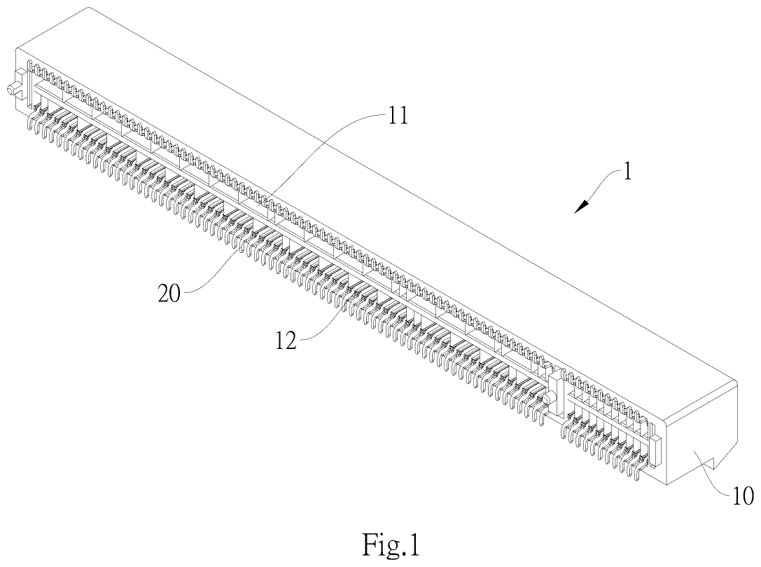

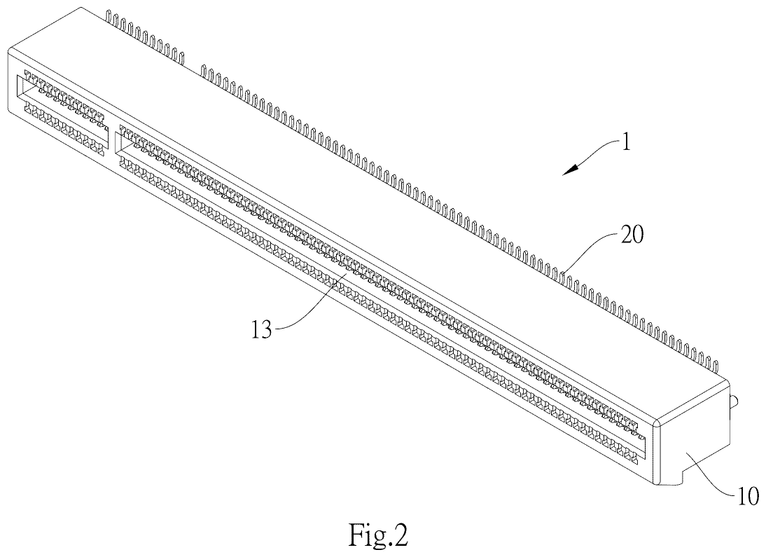

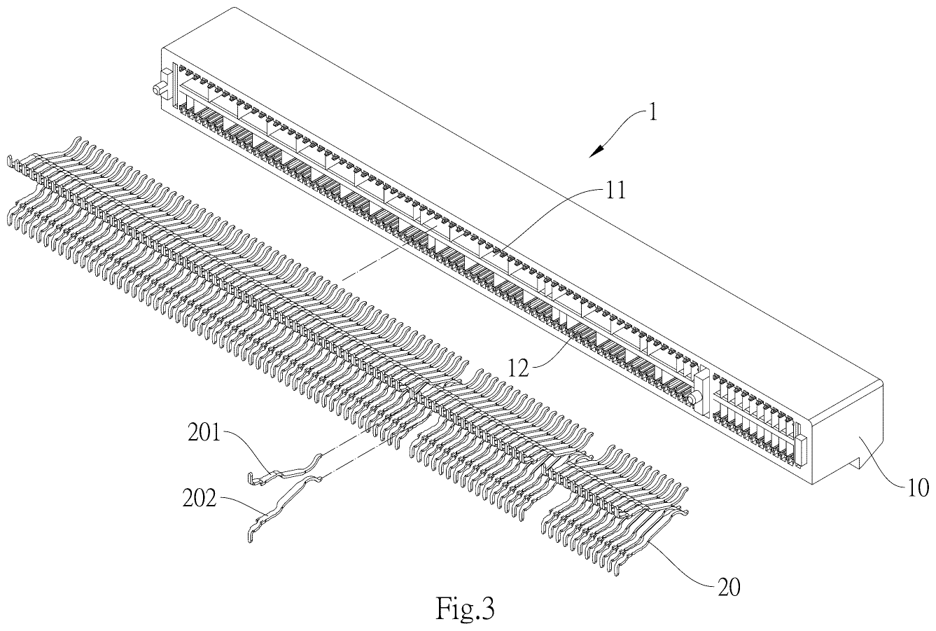

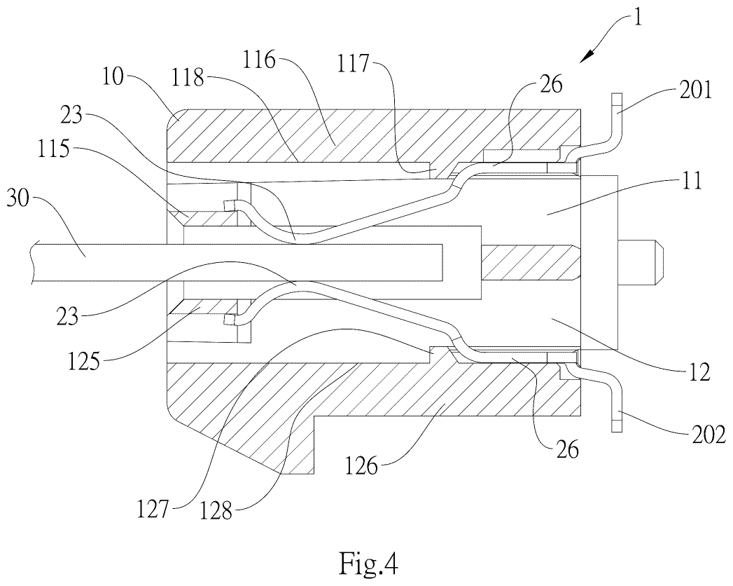

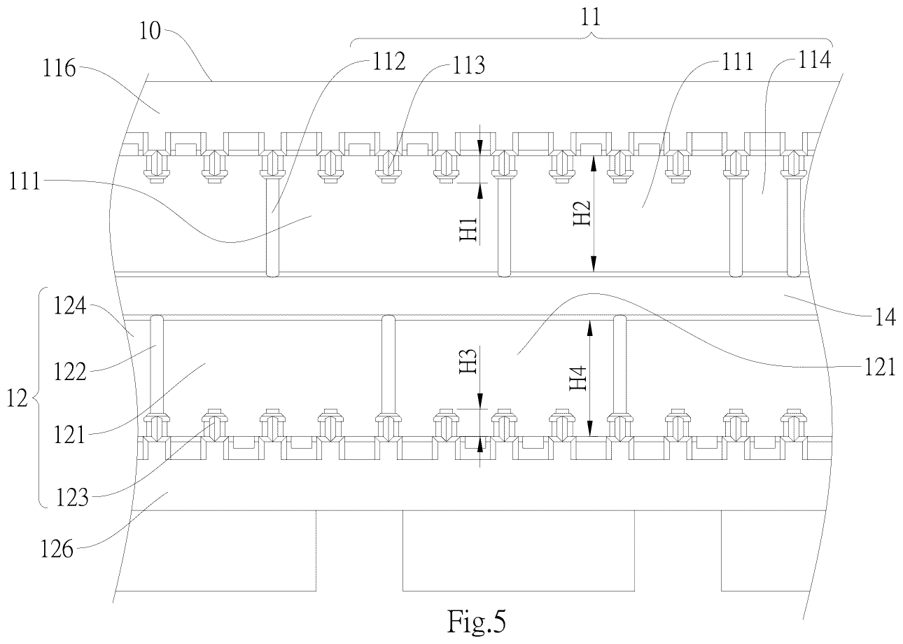

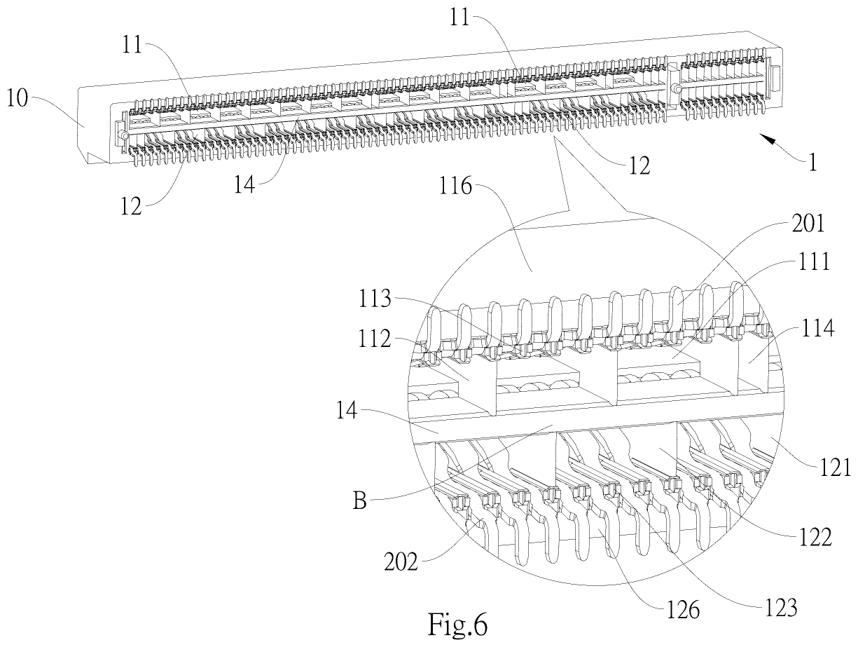

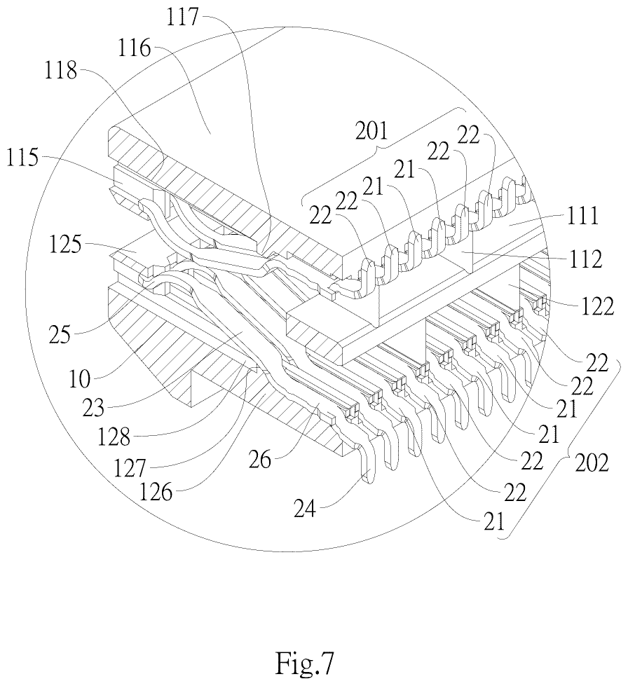

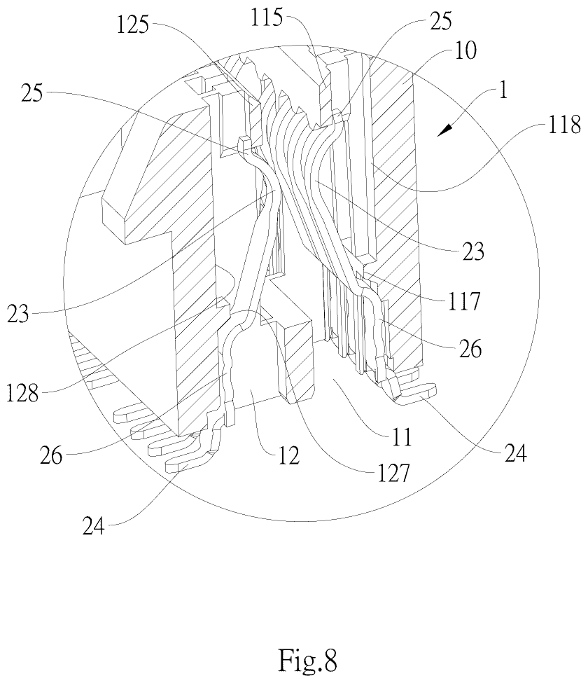

First, refer to FIG. 1 to FIG. 8, FIG. 1 is a schematic front view showing an overall structure of an electrical connector structure according to one embodiment of the present disclosure, FIG. 2 is a schematic back view showing an overall structure of an electrical connector structure according to one embodiment of the present disclosure, FIG. 3 is a schematic explosion diagram showing an overall structure of an electrical connector structure according to one embodiment of the present disclosure, FIG. 4 is a schematic side view showing an overall structure of an electrical connector structure according to one embodiment of the present disclosure, FIG. 5 is a schematic diagram showing arrangement of a first terminal slot and a second terminal slot of an electrical connector structure according to one embodiment of the present disclosure, FIG. 6 is another one schematic diagram showing arrangement of a first terminal slot and a second terminal slot of an electrical connector structure according to one embodiment of the present disclosure, FIG. 7 is a schematic enlarged view showing partial conductive terminals of an electrical connector structure according to one embodiment of the present disclosure, and FIG. 8 is another one schematic enlarged view showing partial conductive terminals of an electrical connector structure according to one embodiment of the present disclosure. The electrical connector structure (1) of the present disclosure at least comprises an insulation base (10) and a plurality of conductive terminals (20), wherein the conductive terminals (20) can be divided into a plurality of differential signal terminals (21) and a plurality of ground terminals (22), each adjacent twos of the differential signal terminals (21) are one pair of the differential signal terminals (21) which respectively transmit a positive different signal and a negative differential signal, and the two ground terminals (22) are disposed on two opposite sides of the pair of the differential signal terminals (21). Generally, one side of the ground terminal (22) which is not adjacent to the differential signal terminal (21) is also disposed with another one ground terminal (22). When adopting the standard of PCIe (especially, the fifth generation PCIe), the specification of the conductive terminals (20) can be referred to https://zh.wikipedia.org/wiki/PCI_Express. In addition to the differential signal terminals (21) and the ground terminals (22), the conductive terminals (20) further comprise other signal terminals or power terminals. The hardware of the electrical connector structure (1) of the present disclosure is designed for the pair of the adjacent two differential signal terminals (21) and the two ground terminal (22), so as to make the paired differential signal terminals (21) efficiently transmit high-frequency signals at a high speed.

The electrical connector structure (1) of the present disclosure has a first terminal slot (11) and a second terminal slot (12), and the first terminal slot (11) is stacked on the second terminal slot (12), wherein in each of the first terminal slot (11) and the second terminal slot (12), there are two adjacent conductive terminals (20) forming a pair of differential signal terminals (21) for transmitting paired different signals. By making the paired differential signal terminals (21) not completely isolated to each other and making the two ground terminals (22) adjacent to the paired differential signal terminals (21) not completely isolated to the differential signal terminals (21) respectively, the two differential signal terminals (21) can efficiently transmit the high-frequency signals at a high speed. Moreover, by effectively widening the widths of the conductive terminals (20) and shortening the lengths (L) of the conductive terminals (20), the impendences which the conductive terminals (20) are exposed to the air can be reduced, and it exactly achieves at least one of reducing the energy loss during the high-frequency signal transmission, improving the quality of the high-frequency signal transmission and increasing the bandwidth of the overall electrical connector structure. Further, in the present disclosure, that the two conductive terminals (20) are not completely isolated to each other means that no partition sheets or partition walls are disposed between the two conductive terminals (20), or a partition sheet with a height less than that of the partition wall is disposed between the two conductive terminals (20), i.e., a middle insulation part is partially removed. In the embodiment, for example, that the two conductive terminals (20) are not completely isolated to each other means that a partition sheet with a height less than that of the partition wall is disposed between the two conductive terminals (20).

The insulation base (10) at least comprises a first terminal slot (11), a second terminal slot (12) and a card slot (13), wherein the first terminal slot (11) comprises a plurality of first section regions (111), a plurality of first partition walls (112), a plurality of first partition sheets (113), a plurality of first slots (114) and a first support plate (115), two adjacent first section regions (111) are completely isolated by one of the first partition walls (112), and the first section region (111) and the first slot (114) can be completely by other one of the first partition walls (112). The first partition sheets (113) are disposed in an inner side of the first section region (111), and the insulation base (10) further comprises a first side wall (116) and an inner side wall (14), wherein the first side wall (116) is disposed on a side of the first section region (111) same to the inner side of the first section region (111), and the inner side wall (14) is disposed on a side opposite to the inner side of the first section region (111). For example, the inner side of the first section region (111) (the upper side of the first section region (111)) has the first partition sheets (113), and compared to the first partition wall (112), the first partition sheets (113) cannot completely isolate the conductive terminals (20). Specifically, as shown in FIG. 5, the first partition wall (112) is extending from the first side wall (116) to the inner side wall (14), and the first partition sheets (113) are slightly extended from the first side wall (116) but not the inner side wall (14), that is, the height (H2) of the first partition wall (112) is less than the height (H1) of the first partition sheet (113). Further, refer to the enlarged view of FIG. 6, and the first partition sheet (113) and/or the second partition sheet (123) are aligned to the boundary (B) of the inner side wall (14), but do not protrude from the boundary (B), such that the electrical connector structure (1) can stably contact the corresponding connector when the electrical connector structure (1) is plugged. In other one preferred embodiment, the inner side of the first section region (111) (for example, as shown in FIG. 6, the upper inner side of the first section region (111)) has three first partition sheets (113) disposed at an equal interval. The first support plate (115) are disposed between the first terminal slot (11) and the card slot (13), wherein the first support plate (115) is used to support the conductive terminals (20) disposed in the first terminal slot (11). In one preferred embodiment, the first partition wall (112) is formed by one first partition sheets (113) and a wall plate (not shown in drawings), and the present disclosure is not limited thereto. In other one embodiment, the first partition wall (112) is formed by only one wall plate (not shown in drawings).

The second terminal slot (12) is disposed in one side of the first terminal slot (11), for example, a lower side, wherein the second terminal slot (12) comprises a plurality of second section regions (121), a plurality of second partition walls (122), a plurality of second partition sheets (123), a plurality of second slots (124) and a second support plate (125). The two adjacent second section regions (121) are completely isolated by one of the second partition walls (122), and the second section region (121) and the second slot (124) are completely isolated by other one of the second partition walls (122). The second partition sheets (123) are disposed in an inner side of the second section region (121) opposite to the inner side of the first section region (111), and the insulation base (10) further comprises a second side wall (126), wherein the second side wall (126) is disposed on a side of the second section region (121) same to the inner side of the second section region (121), and the inner side wall (14) is disposed on a side opposite to the inner side of the second section region (121). For example, the inner side of the second section region (121) (the upper side of the second section region (121)) has the second partition sheets (123), and compared to the second partition wall (122), the second partition sheets (123) cannot completely isolate the conductive terminals (20). Specifically, as shown in FIG. 5, the second partition wall (122) is extending from the second side wall (126) to the inner side wall (14), and the second partition sheets (123) are slightly extended from the second side wall (126) but not the inner side wall (14), that is, the height (H4) of the second partition wall (122) is less than the height (H3) of the second partition sheet (123). Further, refer to the enlarged view of FIG. 6, and the first partition sheet (113) and/or the second partition sheet (123) are aligned to the boundary (B) of the inner side wall (14), but do not protrude from the boundary (B), such that the electrical connector structure (1) can stably contact the corresponding connector when the electrical connector structure (1) is plugged. In other one preferred embodiment, the inner side of the second section region (121) (for example, as shown in FIG. 6, the lower inner side of the second section region (121)) has three second partition sheets (123) disposed at an equal interval. The second support plate (125) are disposed between the second terminal slot (12) and the card slot (13), wherein the second support plate (125) is used to support the conductive terminals (20) disposed in the second terminal slot (12). In one preferred embodiment, the second partition wall (122) is formed by one second partition sheets (123) and a wall plate (not shown in drawings), and the present disclosure is not limited thereto. In other one embodiment, the second partition wall (122) is formed by only one wall plate (not shown in drawings).

Further, each of the conductive terminals (20) comprises a contacting part (23), a welding part (24), an abutting part (25) and a body part (26). As shown in FIG. 4, the each two first partition sheets (113) form a first terminal accommodation slot (118), and the conductive terminal (20) comprises the body part (26) and a contacting part (23) connected to one end of the body part (26). The body part (26) is disposed in the first terminal accommodation slot (118), and the contacting part (23) is disposed far away from a wall surface of the first terminal accommodation slot (118). A first rib (117) is disposed between the wall surface of the first terminal accommodation slot (118) and the contacting part (23). The first rib (117) is designed to be close to the contacting part (23) of the conductive terminal (20), and since the permittivity of the first rib (117) is larger than the permittivity of air, the relative permittivity around the plurality of conductive terminals (20) is relatively large, thereby achieving the effect of reducing impedance. Specifically, The relative permittivity around the conductive terminal (20) is originally the difference between the permittivity of conductive terminal (20) and the permittivity of air, but in the design of using the first rib (117), the relative permittivity around the conductive terminal (20) is the difference between the permittivity of conductive terminal (20) and the permittivity of the first rib (117), thus increasing the relative permittivity around the conductive terminal (20). Further, the each two second partition sheets (123) form a second terminal accommodation slot (128), the body part (26) of the conductive terminal (20) is disposed in the second terminal accommodation slot (128), and the contacting part (23) is disposed far away from a wall surface of the second terminal accommodation slot (128), and a second rib (127) is formed between the wall surface of the second terminal accommodation slot (128) and the contacting part (23). The second rib (127) is designed to be close to the contacting part (23) of the conductive terminal (20), and since the permittivity of the second rib (127) is greater than that of air, the relative permittivity around the plurality of conductive terminals (20) is relatively large, thereby achieving the effect of reducing impedance.

In one preferred embodiment, at least one of the first partition sheet (113) and the second partition sheet (123) is partially removed, and for example, a portion of the first partition sheet (113) or the second partition sheet (123) adjacent to a socket of the card slot is removed. Therefore, the height (H1 or H3) of the first partition sheet (113) or the second partition sheet (123) adjacent to the socket is less than that of other part of the partially removed first partition sheet (113) or the partially removed second partition sheet (123). Further, the partially removed first partition sheet (113) or the partially removed second partition sheet (123) is not aligned to the boundary (B) of the inner side wall (14) and does not protrude from the boundary (B).

In the embodiment of the present disclosure, the first partition sheets (113), the first partition walls (112), the second partition sheets (123) and the second partition walls (122) can be formed in the following way. A plurality of partition sheets and a plurality of wall plates respectively connected to the partition sheets are formed at the same time, and then the plurality of wall plates are removed to form the first partition sheets (113) and the second partition sheets (123), and next, the non-partially removed wall plates and their corresponding partition sheets form the first partition walls (112) and the second partition walls (122). However, the formation methods of the above first partition sheets (113), the first partition walls (112), the second partition sheets (123) and the second partition walls (122) are not intended to limit the present disclosure.

Furthermore, the card slot (13) is opened and set between the first terminal slot (11) and the second terminal slot (12), that is, the card slot (13) is covered the first terminal slot (11) and the second terminal slot (12). The card slot (13) provides a card (30) to be inserted therein, and the card (30) can be, for example, an electrical card with internal electronic circuits (not shown in drawings), for example, sound card, network card, mining card or display card, etc., and the present disclosure is not limited thereto.

The conductive terminals (20) are inserted in the first section regions (111) and the second section regions (121), the conductive terminals (20) inserted in the first section regions (111) of the first terminal slot (11) are first conductive terminals (201), and the conductive terminals (20) inserted in the second section regions (121) of the second terminal slot (21) are second conductive terminals (202). The first conductive terminal (201) or the second conductive terminal (202) can be one of the differential signal terminal (21) or the ground terminal (22).

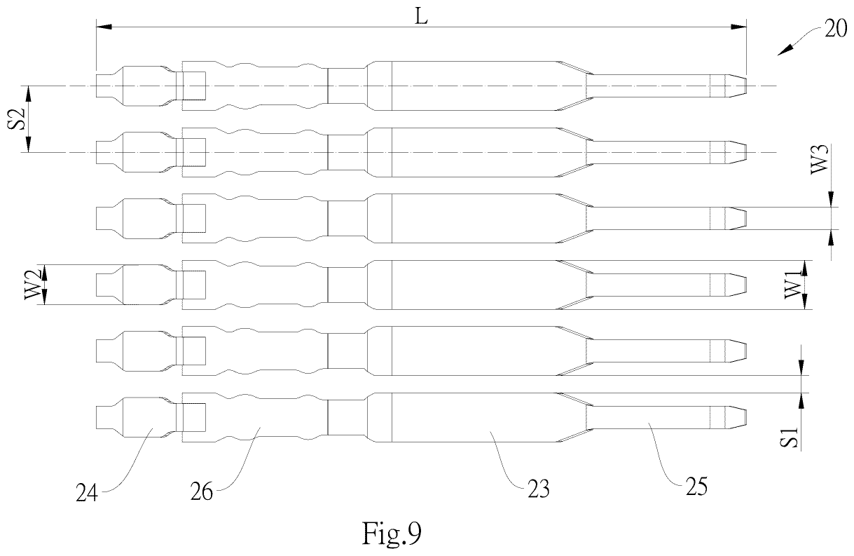

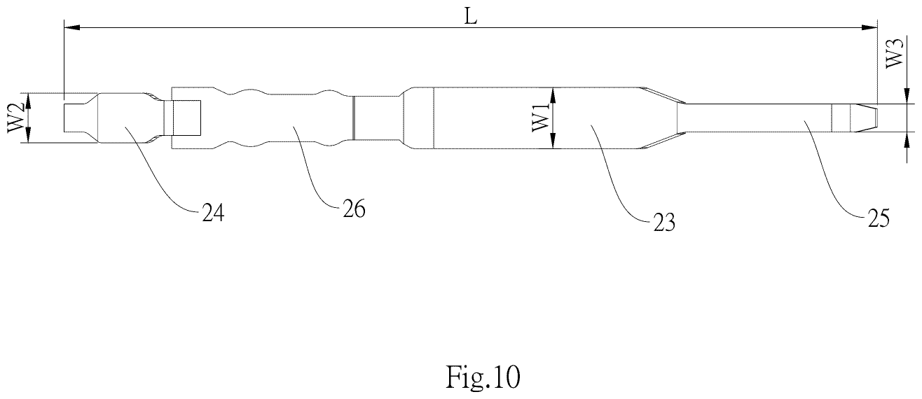

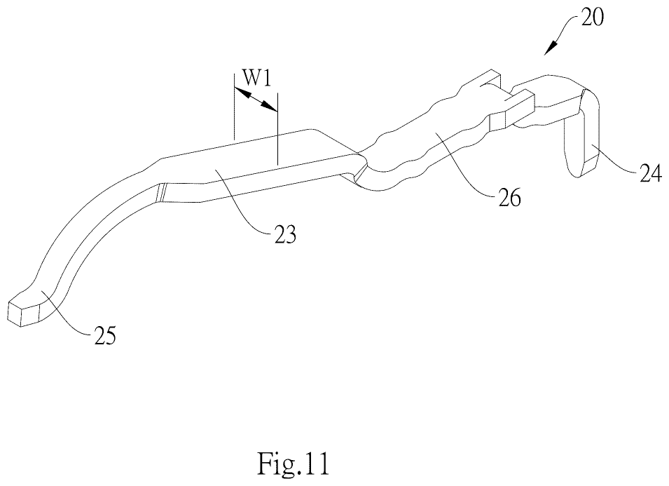

Refer to FIG. 9 to FIG. 11, FIG. 9 is a schematic diagram showing arrangement of conductive terminals of an electrical connector structure according to one embodiment of the present disclosure, FIG. 10 is a schematic diagram showing a structure of a conductive terminal in an electrical connector structure according to one embodiment of the present disclosure, and FIG. 11 is a schematic three-dimensional view showing a structure of a conductive terminal in an electrical connector structure according to one embodiment of the present disclosure. Regarding the detailed components disposed in the first terminal slot (11), each of the first section regions (111) is inserted with four conductive terminals (20), which are respectively paired two differential signal terminals (21) and two ground terminals (22), wherein the paired two differential signal terminals (21) are arranged adjacent to each other in the middle of the first section region (111), and the two ground terminals (22) are respectively arranged on the two opposite sides of the differential signal terminals (21). That is, each of the ground terminals (22) is adjacent to one of the differential signal terminals (21). For example, the ground terminal (22) is provided on the left side of the differential signal terminal (21) on the left side of the middle, and the ground terminal (22) is provided on the right side of the differential signal terminal (21) on the right side of the middle. In each first section region (111), the first partition sheet (113) is arranged between any two adjacent conductive terminals (20) to separate and locate the two adjacent conductive terminals (20). There is no such first partition wall (112) between the two adjacent differential signal terminals (21), and there is no such first partition wall (112) between the differential signal terminal (21) and the ground terminals (22) adjacent to the differential signal terminal (21). The first distance (S1) between any two conductive terminals (20) is about 0.24 mm±2 mm, preferably 24 mm, and the second distance (S2) between the central positions of the two adjacent conductive terminals (20) is about 1 mm. In other words, one of the first partition sheets (113) is disposed between the two differential signal terminals (21), and another one of the first partition sheets (113) is disposed between the differential signal terminal (21) and ground terminal (22) adjacent to the differential signal terminal (21), so as to achieve the effect of separation and positioning. The paired differential signal terminals (21) can efficiently transmit high-frequency signals at high speed, and the ground terminals (22) are used to absorb and shield noise and interference generated by the differential signal terminals (21) when transmitting high-frequency signals. Since the amplitudes of the high-frequency signals transmitted by the same pair of differential signal terminals (21) are the same, but the phases are opposite, there is a problem of high-frequency interference between the pair of differential signal terminals (21). If the ground terminals (22) that are not completely isolated are directly disposed on both sides of the pair of the differential signal terminals (21), the ground terminals (22) can effectively absorb the noise and interference generated by the differential signal terminals (21). Furthermore, one of the conductive terminals (20) is also arranged in the first slot (114), and the type of the conductive terminals (20) is determined according to the PCIe standard specification (especially PCIe fifth generation standard).

In addition, this second terminal slot (12) also has identical configuration with this first terminal slot (11). Each of the second section regions (121) is inserted with four conductive terminals (20), which are respectively paired two differential signal terminals (21) and two ground terminals (22), wherein the paired two differential signal terminals (21) are arranged adjacent to each other and in the middle of the first section region (111), and the two ground terminals (22) are respectively arranged on the two opposite sides of the differential signal terminals (21). That is, each of the ground terminals (22) is adjacent to one of the differential signal terminals (21). For example, the ground terminal (22) is provided on the left side of the differential signal terminal (21) on the left side of the middle, and the ground terminal (22) is provided on the right side of the differential signal terminal (21) on the right side of the middle. In each second section region (121), the second partition sheet (123) is arranged between any two adjacent conductive terminals (20) to separate and locate the two adjacent conductive terminals (20). There is no such second partition wall (122) between the two adjacent differential signal terminals (21), and there is no such second partition wall (122) between the differential signal terminal (21) and the ground terminals (22) adjacent to the differential signal terminal (21). The first distance (S1) between any two conductive terminals (20) is about 0.24 mm±2 mm, preferably 24 mm, and the second distance (S2) between the central positions of the two adjacent conductive terminals (20) is about 1 mm. In other words, one of the second partition sheets (123) is disposed between the two differential signal terminals (21), and another one of the second partition sheets (123) is disposed between the differential signal terminal (21) and ground terminal (22) adjacent to the differential signal terminal (21), so as to achieve the effect of separation and positioning. The paired differential signal terminals (21) can efficiently transmit high-frequency signals at high speed, and the ground terminals (22) are used to absorb and shield noise and interference generated by the differential signal terminals (21) when transmitting high-frequency signals. Since the amplitudes of the high-frequency signals transmitted by the same pair of differential signal terminals (21) are the same, but the phases are opposite, there is a problem of high-frequency interference between the pair of differential signal terminals (21). If the ground terminals (22) that are not completely isolated are directly disposed on both sides of the pair of the differential signal terminals (21), the ground terminals (22) can effectively absorb the noise and interference generated by the differential signal terminals (21). Furthermore, one of the conductive terminals (20) is also arranged in the second slot (124), and the type of the conductive terminals (20) is determined according to the PCIe standard specification (especially PCIe fifth generation standard).

Moreover, the conductive terminal (20) further comprises an abutting part (25), one end of the abutting part (25) is connected to the contacting part (23), and the two ends of the contacting part (23) are respectively connected to the abutting part (25) and the body part (26). Each conductive terminal (20) further comprises a welding part (24) connected to the other end of the contacting part (23). As shown in FIG. 11, from left to right, the conductive terminal (20) is respectively provided with the abutting part (25), the contacting part (23) physically connected to the abutting part (25), and the body part (26) physically connected to the contacting part (23), and the welding part (24) physically connected to the body part (26), wherein the abutting part (25) abuts against the first terminal slot (11) and abuts against the first support plate (115), and the welding part (24) protrudes from the insulation base (10) and is fixed to a circuit board (not shown in drawings, such as a main board or a card slot expansion board) in a fixed manner, wherein the fixed manner is surface mount or dual in-line package, and in a preferred embodiment of the present disclosure, the welding part (24) is fixed to the circuit board by dual-in-line package.

Furthermore, the contacting part (23) has a first width (W1), and the welding part (24) has a second width (W2), wherein the first width (W1) is 0.66 mm to 0.82 mm, preferably 0.76 mm, and the second width (W2) is 0.52 mm and 0.68 mm, preferably 0.65 mm. In addition, the abutting part (25) has a third width (W3), the third width (W3) is preferably 0.34 mm, the width of the conductive terminal (20) of the electrical connector structure (1) of the present disclosure is wider than the conventional conductive terminal, and the length is also shorter. The length (L) of the conductive terminal (20) is about 9.63 mm Because the higher the bandwidth of the transmitted signal, the shorter the wavelength, if the length of the conductive terminal (20) is shortened, the bandwidth of the electrical connector structure (1) can be increased.

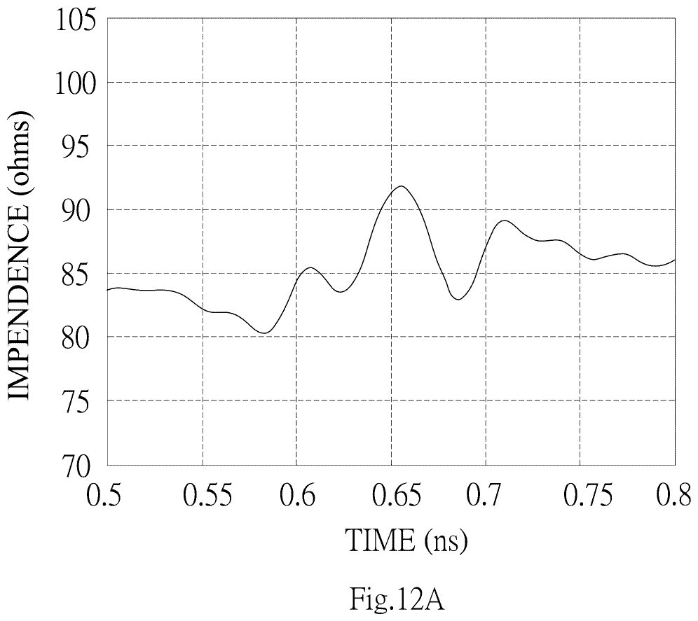

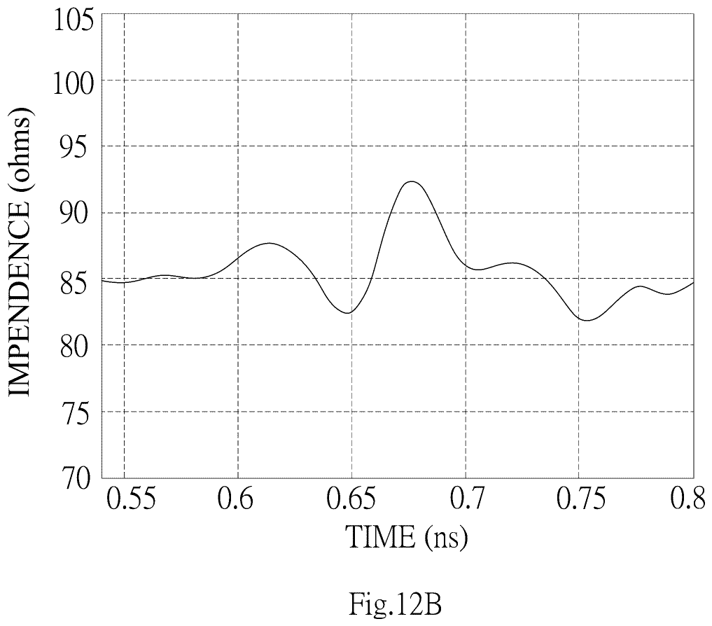

Refer to FIG. 12A and FIG. 12B, and a impedance time domain reflectometry (TDR) is used to measure time-varied impedances of the conductive terminal and the electrical connector structure of the present disclosure, that is, FIG. 12A is a schematic curve diagram of a time-varied impendence of a conductive terminal of a conventional electrical connector structure, and FIG. 12B is a schematic curve diagram of a time-varied impendence of a conductive terminal of an electrical connector structure according to one embodiment of the present disclosure. The unit of X axis is nanosecond, and the unit of Y axis is ohm. The widths of the contacting part and the welding part of the conventional conductive terminal are respectively 0.7 mm and 0.54 mm, and the measured time-varied impedance at about 0.65 nanoseconds is larger than 90 ohms (see the two peaks of FIG. 12A). Compared to the conventional conductive terminal, the widths (W1 and W2) of the contacting part (23) and the welding part (24) of the conductive terminal (20) are respectively increased to 0.76 mm and 0.65 mm, and the measured time-varied impedance of the overall electrical connector structure (1) at about 0.65 nanoseconds is decreased to about 85 ohms or less. Thus, the electrical connector structure (1) of the present disclosure can efficiently reduce the impedance which the conductive terminals (20) are exposed to the air, and can reduce the energy loss during the high-frequency signal transmission.

From the above embodiments, compared the electrical connector structure of the present disclosure with the current marketed products, the technical solution of the present disclosure has the following pros. In the present disclosure, at least one of terminal slots disposed on an upper row and a lower row has a pair of differential signal terminals and two ground terminals, wherein the two differential signal terminals are not completely isolated to each other, the two ground terminals disposed on the two opposite sides of the pair of differential signal terminals, and the ground terminal and the differential signal terminal adjacent to the ground terminal are not completely isolated to each other. By using the above hardware design, the pair of the differential signal terminals can efficiently and fast transmits the high-frequency signals. Furthermore, by using the design that the ribs are disposed adjacent to the contacting parts of the conductive terminals, since the permittivity of the rib is greater than that of air, the relative permittivity around the plurality of conductive terminals is relatively large, thereby achieving the effect of reducing impedance. Moreover, by effectively widening the widths of the conductive terminals and shortening the lengths of the conductive terminals, the impendences which the conductive terminals are exposed to the air can be reduced, and it exactly achieves at least one of reducing the energy loss during the high-frequency signal transmission, improving the quality of the high-frequency signal transmission and increasing the bandwidth of the overall electrical connector structure.

To sum up, the electrical connector structure illustrated in the embodiment of the present disclosure can exactly solve the technical problems of prior art and achieve the technical results. The details and design of the electrical connector structure of the present disclosure are not disclosed before the present disclosure is filed, and the electrical connector structure of the present disclosure is novel and has inventive steps.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. An electrical connector structure, at least comprising:
an insulation base, comprising a first terminal slot, wherein the first terminal slot comprises a plurality of first section regions, a plurality of first partition walls and a plurality of first partitions sheet, wherein the two adjacent first section regions are completely isolated by the first partition wall, and the first partition sheets are disposed on an inner side of the first section region; and
a plurality of conductive terminals, comprising a plurality of first conductive terminals inserted in the first section regions, wherein each of the first conductive terminals is a first differential signal terminal or a first ground terminal, the two adjacent first differential signal terminals and the two first ground terminals are inserted in the first section region, and in the first section region, the two first ground terminals are respectively disposed on two opposite sides of the two adjacent first differential signal terminals, and the first partition sheet is disposed between the two adjacent first conductive terminals.

2. The electrical connector structure of claim 1, wherein the insulation base further comprises a first side wall, the first side wall is disposed on a side of the first section region same to the inner side of the first section region, each the two first partition sheets form a first terminal accommodation slot, the conductive terminal comprises a body part and a contacting part connected to one end of the body part, the body part of the first conductive terminal is disposed in the first terminal accommodation slot, the contacting part of the first conductive terminal is disposed far away from a wall surface of the first terminal accommodation slot, and a first rib is formed between the wall surface of the first terminal accommodation slot and the contacting part of the first conductive terminal.

3. The electrical connector structure of claim 2, wherein the insulation base further comprises a second terminal slot and a card slot, the second terminal slot is disposed on a side of the first terminal slot, the second terminal slot comprises a plurality of second section regions, a plurality of second partition walls and a plurality of second partition sheets, wherein the two adjacent second section regions are completely isolated by the second partition wall, the second partition sheets corresponding to the first partition sheets are disposed on and connected to an inner side of the second section region, the inner side of the second section region is corresponding to the inner side of the first section region, the card slot is opened and disposed between the first terminal slot and the second terminal slot, the conductive terminals comprise a plurality of second conductive terminals inserted in the second section regions, each of the second conductive terminals is a second differential signal terminal or a second ground terminal, the two adjacent second differential signal terminals and the two second ground terminals are inserted in the second section region, and in the second section region, the two second ground terminals are respectively disposed on two opposite sides of the two adjacent second differential signal terminals, and the second partition sheet is disposed between the two adjacent second conductive terminals.

4. The electrical connector structure of claim 3, wherein the insulation base further comprises a second partition wall, the second partition wall is disposed on a side of the second section region same to the inner side of the second section region, each the two second partition sheets form a second terminal accommodation slot, the body part of the second conductive terminal is disposed in the second terminal accommodation slot, the contacting part of the second conductive terminal is disposed far away from a wall surface of the second terminal accommodation slot, and a second rib is formed between the wall surface of the second terminal accommodation slot and the contacting part of the second conductive terminal.

5. The electrical connector structure of claim 3, wherein each of the conductive terminals comprises a welding part connected to one end of the contacting part, the contacting part has a first width, the welding part has a second width, the first width is 0.66 mm to 0.82 mm, and the second width is 0.52 mm to 0.68 mm.

6. The electrical connector structure of claim 3, wherein a height of the first partition sheet is less than a height of the first partition wall, and a height of the second partition sheet is less than a height of the second partition wall.

7. The electrical connector structure of claim 3, wherein at least one of the first partition sheet and the second partition sheet is partially removed.

8. The electrical connector structure of claim 7, wherein regarding the partially removed the first partition sheet or the second partition sheet, a portion of the first partition sheet or the second partition sheet adjacent to a socket of the card slot is removed.

9. The electrical connector structure of claim 3, wherein the first terminal slots further comprise a first slot, the first slot is adjacent to the first section region, the first slot and the first section region are completely isolated by the first partition wall, and one of the conductive terminals is disposed in the first slot.

10. The electrical connector structure of claim 3, wherein the second terminal slots further comprise a second slot, the second slot is adjacent to the second section region, the second slot and the second section region are completely isolated by the second partition wall, and one of the conductive terminals is disposed in the second slot.

11. The electrical connector structure of claim 3, wherein the insulation base further comprises at least one first support plate and at least one second support plate, the first support plate is disposed between the first terminal slot and the card slot, and the second support plate is disposed between the second terminal slot and the card slot.

12. The electrical connector structure of claim 3, wherein the electrical connector structure meets a standard of a fifth generation PCIe.

13. The electrical connector structure of claim 3, wherein the card slot is provided to a card for insertion, and interior of the card comprises an electrical circuit.

14. The electrical connector structure of claim 5, wherein the conductive terminal further comprises an abutting part, one end of the abutting part is connected to the contacting part, and another one end of the contacting part is connected to the abutting part while the end of the contacting part is connected to and the body part.

15. The electrical connector structure of claim 4, wherein the insulation base further comprises at least one first support plate, the first support plate is disposed between the first terminal slot and the card slot, and the abutting part of the conductive terminal in the first terminal slot abuts against the first terminal slot and abuts against the first support plate.

16. The electrical connector structure of claim 14, wherein the insulation base further comprises at least one second support plate, the second support plate is disposed between the second terminal slot and the card slot, and the abutting part of the conductive terminal in the second terminal slot abuts against the second terminal slot and abuts against the second support plate.

17. The electrical connector structure of claim 14, wherein the welding part protrudes from the insulation base and is fixed on a circuit board in a fixed manner.

18. The electrical connector structure of claim 17, wherein the fixed manner is surface mount or dual in-line package.

19. The electrical connector structure of claim 1, wherein the insulation base further comprises a second terminal slot disposed on a side of the first terminal slot and a card slot, the second terminal slot comprises a plurality of second section regions, a plurality of second partition walls and a plurality of second partition sheets, wherein the two adjacent second section regions are completely isolated by the second partition wall, the second partition sheets corresponding to the first partition sheets are disposed on and connected to an inner side of the second section region, the inner side of the second section region is corresponding to the inner side of the first section region, the card slot is opened and disposed between the first terminal slot and the second terminal slot, the conductive terminals comprise a plurality of second conductive terminals inserted in the second section regions, each of the second conductive terminals is a second differential signal terminal or a second ground terminal, the two adjacent second differential signal terminals and the two second ground terminals are inserted in the second section region, and in the second section region, the two second ground terminals are respectively disposed on two opposite sides of the two adjacent second differential signal terminals, and the second partition sheet is disposed between the two adjacent second conductive terminals.

20. The electrical connector structure of claim 19, wherein a height of the first partition sheet is less than a height of the first partition wall, and a height of the second partition sheet is less than a height of the second partition wall.
